(19) United States
(12) Patent Application Publication
(10) Pub. No.: US 2012/0168978 A1
(43) Pub. Date: Jul. 5, 2012

(54) HIGH OUTPUT CALIBRATOR ASSEMBLY FOR PIPE EXTRUSION AND RELATED METHODS

(76) Inventor: Hans Groeblaccher, McPherson, KS (US)

(21) Appl. No.: 13/377,784

(22) PCT Filed: Jun. 11, 2010
(86) PCT No.: PCT/US10/38405

§ 371 Date: Mar. 16, 2012

Related U.S. Application Data
(60) Provisional application No. 61/186,255, filed on Jun. 11, 2009.

(51) Int. Cl. B29C 47/90; B29C 47/58

(52) U.S. Cl. 264/101; 425/445

(57) ABSTRACT

An adjustable sizing sleeve for pipe extrusion is provided. The sizing sleeve is a hollow, cylindrical body with a helical gap formed in the body. The helical gap allows the sleeve to be twisted by rotating opposing ends in opposite directions and resulting in a contraction of the inner diameter of the sleeve In another embodiment, a high intensity cooling feature of a calibrator assembly for extrusion is provided. The cooling feature is designed to provide a high Reynolds number and high pressure of cooling fluid flowing to a sizing sleeve (or other calibrator) of an extrusion assembly to provide sufficient cooling of the front-most portion of the sleeve to maximize heat transfer between the outer surface of the material being extruded and the inner surface of the front-most portion of the sleeve to fully solidify the entire surface of the material being extruded

### CROSS-REFERENCE TO RELATED APPLICATIONS

This application claims priority to co-pending U.S. Provisional Patent Application Ser. No. 61/186,255, filed Jun. 11, 2009, the entire disclosure of which is incorporated herein by reference.

### FIELD OF THE INVENTION

The present invention relates generally to apparatus and methods for pipe extrusion. More particularly, the present invention relates to a high output calibrator assembly for pipe extrusion. One aspect of the invention includes an adjustable sizing sleeve assembly and method related thereto. Another aspect of the invention includes a high intensity cooling feature of a calibrator assembly and methods related thereto.

### BACKGROUND OF THE INVENTION

Extrusion is a process used to create objects of a fixed cross-sectional profile. A material is pushed or drawn through a die of the desired cross-section. Extrusion processes are particularly useful to create very complex cross-sections and/or to work materials that are brittle, because the material only encounters compressive and shear stresses. Extrusion processes may utilize a single material (i.e. “mono” extrusion), or may utilize two or more different materials extruded simultaneously to create single or multi-layered, objects.

An extrusion system for pipe or profile extrusion typically includes the following components:

A Material handling system

A Material loading system mounted to extruder feed section

An Extruder (single or twin screw)

A Calibration table (for profile-extrusion) or vacuum cooling tank (for pipe extrusion)

Cooling tank(s)

A Haul-off unit (Flat or contour belt for profile, 4+ belts for pipe)

A Cut-off Saw

A Tip or Dump table/Collection station

The material being extruded, such as a plastic material (in granular or powder form), is conveyed to the extruder feed hopper by the material handling system and gravity fed into the screw feed section of the extruder via the material loading system. The extruder screw(s) are located inside the extruder barrel. The extruder screw(s) convey the plastic material towards the exit of the extruder, and apply shear as well as heat to plasticize the material. The plasticized material will exit the extruder through the extrusion head and ultimately through an extrusion die attached to the head assembly. The extrusion die pre-forms the material into the desired shape (i.e. Pipe/Profile/Sheet/etc.). The cooling and shaping (calibration) of the pre-formed material takes place in a vacuum sizing unit (sizing sleeve for pipe, calibration system for profile). The calibrated product is cut to length by passing through a cut-off saw unit and collected on a Tip or Dump table.

In addition, when hollow shapes are extruded, such as pipes (i.e. circular cross-section) or other cross-sectional profiles, a mandrel is suspended within the head assembly to create the hollow shape by diverting the flow of the plasticized material around the outer surface of the mandrel. A typical extrusion head assembly further includes a melt inlet adapter (or adapters when co-extruding) for receiving the material from the extruder screw(s), a spider plate for supporting the mandrel and directing the flow of material around the surface of the mandrel, an inventory section for collecting material prior to shaping through the die, and an extrusion tooling adapter plate on which an extrusion die is attached.

Typical vacuum sizing units for pipe (circular cross-section profiles) include a generally cylindrical metal sizing sleeve through which the preformed material is fed as it exits the die. The sizing sleeve includes an inner surface cross sectional shape and dimension generally along the length of its axis that matches the final desired shape and dimension of the pipe. Typically, this shape and dimension is slightly smaller than the shape and dimension of the preformed material as it exits the die. As the preformed material is fed through the length of the sizing sleeve, the exterior surface of the material is compressed to the final desired shape and dimension by the interior surface of the sleeve, and is simultaneously cooled through heat transfer from the generally hotter material to the generally cooler sleeve.

Air, water or other coolants are often circulated around the sleeve to cool the sleeve and improve the heat exchange between the sleeve and the preformed material. Notwithstanding, as the preformed material is fed through the sleeve, certain portions of the surface of the material cool before other portions of the surface, causing the cooled portions of surface of the preformed material to pull away from or loose contact with the inner surface of the sleeve, creating an air gap between the sleeve and the material. This air gap reduces the heat transfer from the material to the sleeve and the uneven cooling results in surface imperfections which can impact the quality of the pipe. Therefore, it would be beneficial to provide a sizing sleeve that eliminates these cooling problems.

In addition, many sizing sleeves have been developed that allow the exact dimension of the inner surface of the sleeve to be adjusted, to allow a single sleeve to be utilized for manufacturing pipes of a variety of different dimensions, and/or to allow for dimensional variations in the manufacturing process. The adjustability of such sleeves is accomplished in a variety of different methods. Most all methods include some type of gap or slit that is formed through a portion of the sleeve; the gap is either compressed or expanded through the use of an external force applied to the sleeve to either reduce or increase, respectively, the dimension of the inner diameter of the sleeve.

A simple example utilizes a generally linear gap that extends along the entire axial length of the sleeve. When a compressive force is applied to the outer surface of the sleeve, the gap is compressed and the dimension of the inner diameter of the sleeve is reduced; when the force is removed, the diameter increases to its original dimension. As the sleeve is compressed, the shape of the cross section will tend to change from a perfectly round shape to a non-round, generally egg shape. This results in a pipe outer surface that is also egg-shaped. In addition, the preformed material will tend to fill the gap as it moves through the sizing sleeve, resulting in a surface imperfection on the extruded pipe. In attempts to overcome these problems, a variety of gap geometries have been developed. For example, sizing sleeves with multiple gaps and/or gaps that form wavy, nonlinear lines have been developed. While these developments decrease the problems discussed above, and in some cases are able to eliminate one of the problems (i.e. either eliminate the roundness problem, but still have surface imperfections, or vice versa), prior to the advent of the instant invention, no adjustable sizing sleeve has been developed that creates generally perfectly round pipe for all ranges of dimensions to which the sleeve may be adjusted, and at the same time eliminates the surface imperfections caused by the gap(s) in the sleeve. Therefore, it would be beneficial to provide an adjustable sizing sleeve that results in consistently round pipe through all dimensions to which the sleeve may be adjusted, and that also eliminates the surface imperfections caused by the adjustment gaps located in conventional adjustable sleeves.

### SUMMARY OF THE INVENTION

Shortcomings with aspects of conventional sizing sleeves (calibrator assemblies) and methods are addressed by the present invention as shown and described in a variety of illustrative embodiments herein. The calibrator assembly described herein involves multiple aspects that, when utilized together, will significantly improve calibration of extruded pipes. Nevertheless, each individual aspect described herein achieves improvements in calibration over the devices and methods of the prior art. Therefore, it will be appreciated that aspects of various embodiments disclosed herein may be utilized alone, or in combination with other aspects of other embodiments without departing from the spirit and scope of the instant invention and regardless of whether such specific combinations are specifically set forth herein.

One embodiment of the instant invention includes an adjustable sizing sleeve assembly. Another embodiment of the instant invention includes a high intensity cooling feature of a calibrator assembly. It will be appreciated that the adjustable sizing sleeve assembly and the high intensity cooling feature may be utilized separate from one another, or may be utilized in combination with one another, regardless of whether such combinations/embodiments are specifically discussed herein.

The adjustable sizing sleeve of an embodiment of the invention is a generally hollow, cylindrical body with a gap cut or otherwise formed in the body of the sleeve in the shape of a helix. The helical gap allows the sleeve to be twisted by rotating the opposing ends in opposite directions and resulting in a contraction of the inner diameter of the cylindrical sleeve. This provides the adjustment for varying diameters of pipe to be calibrated utilizing the sleeve. The helical gap allows the sleeve to be compressed evenly around its entire circumference over the length of the gap. This results in a pipe that is more perfectly round than adjustable sleeves of the prior art. In addition, the helix-shaped gap eliminates surface imperfections caused by material tending to flow into the gap, as the entire circumference of the material is always forced across a gapless surface after crossing a portion of the gap.

In preferred embodiments, the helix-shaped gap does not extend all the way through the sleeve body to either the front or rear ends of the sleeve. In other words, the gap terminates prior to either end (front and rear) of the sleeve. As a result, when the ends of the sleeve are twisted to reduce the inner diameter of the cylinder, the inner diameter at each end of the cylinder will be greater than the inner diameter throughout the central portion of the cylinder. This allows the material being calibrated to exit the sleeve with no flat spots as the gapless transition from the end of the gap will smooth any flat spots created by material tending to flow into the gap. Then as the diameter of the cylinder of the sizing sleeve increases further toward the end, the material being calibrated will no longer be compressed or shaped by the sleeve and will remain round and without surface imperfections.

The high intensity cooling feature of a calibrator assembly of an embodiment of the invention includes a channel for water (or other cooling fluid) to flow around the front-most portion of the calibrator assembly, providing a constant flow of water around the calibrator. The water then flows from the front-most portion of the calibrator towards the rear end of the calibrator along the outer surface of the calibrator. The cooling feature is designed to provide a high Reynolds number and high pressure fluid flow to provide sufficient cooling of the front-most portion of the calibrator to result in maximum heat transfer between the outer surface of the material being extruded and the inner surface of the front-most portion of the calibrator to fully solidify the entire surface of the material being extruded. The amount of cooling, Reynolds number and amount of water to provide is calculated based upon the glass transition temperature of the material being extruded. The volume of water provided may be increased or decreased depending upon the amount of cooling that is necessary or desired. In a preferred embodiment, a relatively low glass transition temperature is utilized so that a variety of different materials may be utilized. In some preferred embodiments, the sum of the cross-sectional area of inlets through of the cooling feature to create fluid flow is generally ½ the cross sectional area of the header for the calibrator. This results in a constant fluid pressure in the header and a high velocity of fluid flow from the header through the inlets. In other embodiments, the inlets are positioned around the header at equal distances from one another to provide equal pressure around the entire header and calibrator. It will be appreciated that the number of inlets, dimensions of the inlets, and dimensions of the header may vary depending upon the amount of cooling desired. In one preferred embodiment, the number of inlets is varied depending upon the amount of cooling desired, while the dimensions of the inlets and dimensions of the header remain constant.

The flow of water (or coolant) described herein causes the front-most portion of the calibrator to fully solidify the very outer surface of the material being extruded, before the material reaches the end of the front-most portion of the calibrator. This results in the outer surface of the material being extruded to be in continuous contact with the inner surface of the front-most portion of the sleeve as it is feed forward, and results in fewer imperfections than sleeves of the prior art.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations, and any feature that is described in a connection to any one embodiment may also be applicable to any other embodiment. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is a side view of an “mono” extrusion line in which an adjustable sizing sleeve and high intensity cooling feature embodiments the instant invention may be utilized.

FIG. 2 is a side view of a co-extrusion line in which an adjustable sizing sleeve and high intensity cooling feature embodiments the instant invention may be utilized.

FIG. 3 is a front perspective view of an adjustable sizing sleeve assembly generally representative of several embodiments of the instant invention.

FIG. 4 is a perspective exploded view of a first embodiment of the adjustable sizing sleeve assembly of FIG. 3.

FIG. 5 is a perspective exploded view of a second embodiment of the adjustable sizing sleeve assembly of FIG. 3.

FIG. 6 is a perspective exploded view of a third embodiment of the adjustable sizing sleeve assembly of FIG. 3.

FIG. 7 is a front perspective and partially exploded view of the adjustment assembly of the adjustable sizing sleeve assembly of FIG. 3.

FIG. 8 is a section view taken along A-A of FIG. 3 of the adjustable sizing sleeve assembly embodiment of FIGS. 3 and 4.

FIG. 9 is a front view of an adjustable sizing sleeve assembly of another embodiment of the instant invention.

FIG. 10 is a side view of the adjustable sizing sleeve assembly of FIG. 9.

FIG. 11 is a sectional view of an embodiment of a fixed diameter sizing sleeve assembly of the instant invention.

FIG. 12 is a sectional view of another embodiment of a fixed diameter sizing sleeve assembly of the instant invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and/or chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

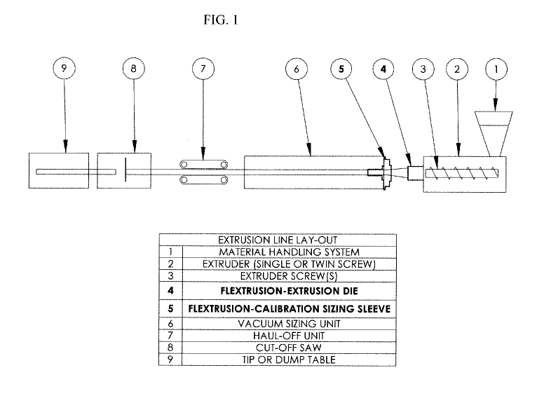

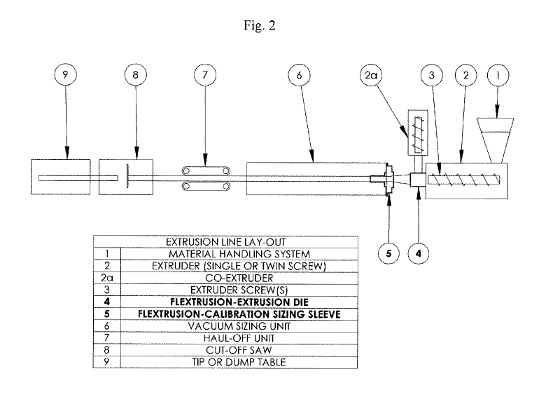

FIGS. 1 and 2 show exemplary embodiments of extrusion lines in which the adjustable sizing sleeve and high intensity cooling feature, and respective methods, of the instant invention are utilized. FIG. 1 shows a “mono” extrusion line in which one layer of material is extruded, while FIG. 2 shows a co-extrusion line in which two layers of material is extruded, to form a conduit or other profile object. Referring to FIG. 1, material handling system 1, provides the material being extruded to extruder 2. The screw (or screws), 3, of extruder 2 pushes the material through the extruder head/die assembly 4 which is attached to the outlet of extruder 2.

The extrusion die pre-forms the material into the desired shape (i.e. Pipe/Profile/Sheet/etc.). The cooling and shaping (calibration) of the pre-formed material takes place in a calibration sleeve 5 of one or more of the embodiments of the instant invention (discussed in further detail below) that is located at an opening of a vacuum sizing unit 6. The calibrated product is transported from the outlet of vacuum sizing unit 6 via haul-off unit 7 to cut-off saw 8 where it is cut to length by passing through a cut-off saw and then collected on a Tip or Dump table 9. Referring to FIG. 2, material handling system 1, provides a base material being extruded to extruder 2. The material handling system, or an additional material handling system, provides a second material being extruded to co-extruder 2a, which includes either a single or twin extruder screw(s). The screw (or screws), 3, of extruders 2 and 2a push the material through the co-extruder head/die assembly 4 which is attached to the outlet of extruder 2. The extrusion die pre-forms the material into the desired shape (i.e. Pipe/Profile/Sheet/etc.). The cooling and shaping (calibration) of the pre-formed material takes place in a calibration sleeve S of one or more of the embodiments of the instant invention (discussed in further detail below) that is located at an opening of a vacuum sizing unit 6. The calibrated product is transported from the outlet of vacuum sizing unit 6 via haul-off unit 7 to cut-off saw 8 where it is cut to length by passing through a cut-off saw and then collected on a Tip or Dump table 9.

Adjustable Sizing Sleeve with High Intensity Cooling Feature

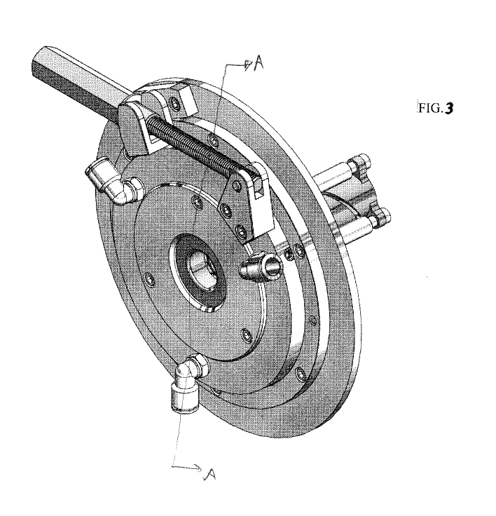

Referring to FIGS. 3 through 8, several embodiments of adjustable sizing sleeve assemblies 5 of the instant invention are shown which also include the high intensity cooling feature of the instant invention. Nevertheless, it will be appreciated that the adjustable sizing sleeve assemblies discussed herein may be utilized without the high intensity cooling feature, and/or that the high intensity cooling feature may be utilized with other calibration assemblies including but not limited to other adjustable sizing sleeves, fixed dimension sizing sleeves, or calibration systems for profiles.

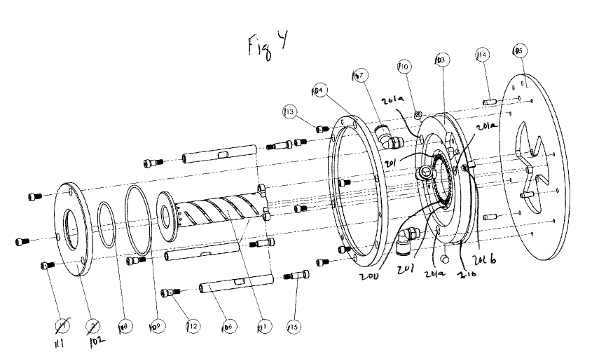

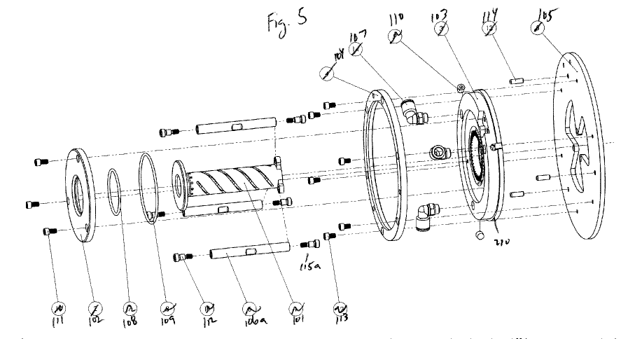

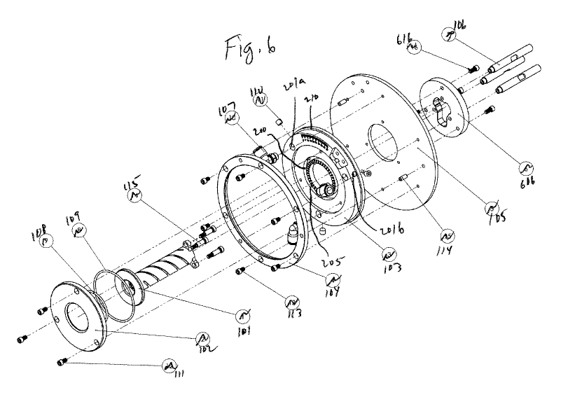

Referring to FIG. 3, a perspective view generally representative of several embodiments of adjustable sizing sleeve assemblies of the instant invention is shown. Referring to FIGS. 4, 5 and 6, perspective exploded views of three embodiments of adjustable sizing sleeve assemblies are shown. All three embodiments include identical components with a few exceptions. The embodiments shown in FIGS. 4 and 6 include “floating” length support bars 106, while the embodiment shown in FIG. 5 includes “fixed” length support bars 106a. Also, in the embodiments shown in FIGS. 4 and 5, a back/exit end of an adjustable sizing sleeve 101 is mounted via support bars 106, 106a directly to a back plate 105 of the assembly, while in the embodiment shown in FIG. 6 includes a support bar mounting plate 606 connected to the back plate 105 and to which support bars 106 are connected.

Referring to the embodiment shown in FIG. 4, the adjustable sizing sleeve assembly includes a triple helix type (discussed in further detail below) adjustable sizing sleeve 101 that includes an annular front end (toward the left of FIG. 4) and a rear end including three protruding tabs that include voids through which screws 115 are extended. Screws 115 extend into threaded cavities of floating support bars 106 to connect support bars 106 to the protruding tabs of sizing sleeve 101. Each screw 115, includes a non-threaded shank portion that is associated with the voids of the protruding tabs. In addition, the length of the screws is such that the protruding tabs may slide back and forward along the non-threaded shank portion as sizing sleeve 101 either expands or contracts in length as part of its size adjustment. This allows the sizing sleeve to “float” on the “floating” support bars. The ends of support bars 106 opposing screws 115 are attached to back plate 105 via screws 112. The annular front end of sizing sleeve 101 is frictionally retained between a rear face of cover plate 102 and a front face of distributor plate 103. Cover plate 102 is connected to distributor plate 103 via screws 111. O-rings 108 and 109 provide a water-tight seal for a water chamber (“header”) 200 created between the rear surface of the cover plate 102 and concentric rings formed in the front surface of the distributor plate 103 to supply water (or another appropriate coolant) to the front end of sizing sleeve 101. The water chamber is provided water via fittings 107 which are connected to an inlet 201a of a water channel 201 formed through distributor plate 103. Plugs 110 are used to seal the water channel 201 such that water only flows into the water chamber and not out through holes 201b created to form the water channel through the distributor plate 103. The distributor plate 103 is attached to back plate 105 via screws 113 that extend through retaining ring 104 which frictionally engages with an annular lip of distributor plate 103 to retain engagement between distributor plate 103 and back plate 105. Dowel pins 114 are used to align retaining ring 104 properly with back plate 105.

Referring to the embodiment shown in FIG. 5, the adjustable sizing sleeve assembly includes a triple helix type (discussed in further detail below) adjustable sizing sleeve 101 that includes an annular front end (toward the left of FIG. 5) and a rear end including three protruding tabs that include voids through which screws 115a are extended. The screws extend into threaded cavities of fixed support bars 106a to connect support bars 106a to the protruding tabs of sizing sleeve 101. Each screw 115a includes a non-threaded shank portion that is associated with the voids of the protruding tabs. The length of the screws 115a is such that the protruding tabs do not slide back and forward along the non-threaded shank portion as sizing sleeve 101 is urged to either expand or contract (through winding or unwinding, respectively, sleeve 101 in the manner discussed below in further detail) in length as part of its size adjustment. This prevents the sizing sleeve from “floating” on the “fixed” length support bars, such that the length of the sizing sleeve is essential forced into a “fixed” length regardless of its adjustment. The ends of support bars 106a opposing the screws 115a through the tabs of sizing sleeve 101 are attached to back plate 105 via screws 112. The annular front end of sizing sleeve 101 is frictionally retained between a rear face of cover plate 102 and a front face of distributor plate 103. Cover plate 102 is connected to distributor plate 103 via screws 111. O-rings 108 and 109 provide a water-tight seal for a water chamber 200 created between the distributor plate 103 and the cover plate 102 to supply water (or another appropriate coolant) to the front end of sizing sleeve 101. The water chamber 200 is provided water via fittings 107 which are connected to an inlet 201a of a water channel 201 formed through distributor plate 103. Plugs 110 are used to seal the water channel 201 such that water only flows into the water chamber 200 and not out through holes 201b created to form the water channel 201 through the distributor plate 103. The distributor plate 103 is attached to back plate 105 via screws 113 that extend through retaining ring 104 which frictionally engages with an annular lip 210 of distributor plate 103 to retain engagement between distributor plate 103 and back plate 105. Dowel pins 114 are used to align retaining ring 104 properly with back plate 105.

Referring to the embodiment shown in FIG. 6, the adjustable sizing sleeve assembly includes a triple helix type (discussed in further detail below) adjustable sizing sleeve 101 that includes an annular front end (toward the left of FIG. 6) and a rear end including three protruding tabs that include voids through which screws 115 are extended. Screws 115 extend into threaded cavities of floating support bars 106 to connect support bars 106 to the protruding tabs of sizing sleeve 101. Each screw 115, includes a non-threaded shank portion that is associated with the voids of the protruding tabs. In addition, the length of the screws is such that the protruding tabs may slide back and forward along the non-threaded shank portion as sizing sleeve 101 either expands or contracts in length as part of its size adjustment. This allows the sizing sleeve to “float” on the “floating” support bars. The ends of support bars 106 opposing screws 115 are attached to support bar mounting plate 606 by positioning a void in the end of support bars 106 over a mating protruding pin located on the back surface of mounting plate 606. Mounting plate 606 is attached to back plate 105 via screws 616. The annular front end of sizing sleeve 101 is frictionally retained between a rear face of cover plate 102 and a front face of distributor plate 103. Cover plate 102 is connected to distributor plate 103 via screws 111. O-rings 108 and 109 provide a water-tight seal for a water chamber 200 created between the distributor plate 103 and the cover plate 102 to supply water (or another appropriate coolant) to the front end of sizing sleeve 101. The water chamber 200 is provided water via fittings 107 which are connected to an inlet 201a of a water channel 201 formed through distributor plate 103. Plugs 110 are used to seal the water channel 201 such that water only flows into the water chamber 200 and not out through holes 201b created to form the water channel 201 through the distributor plate 103. The distributor plate 103 is attached to back plate 105 via screws 113 that extend through retaining ring 104 which frictionally engages with an annular lip 210 of distributor plate 103 to retain engagement between distributor plate 103 and back plate 105. Dowel pins 114 are used to align retaining ring 104 properly with back plate 105. Additional dowel pins may be utilized to align mounting plate 606 with back plate 105.

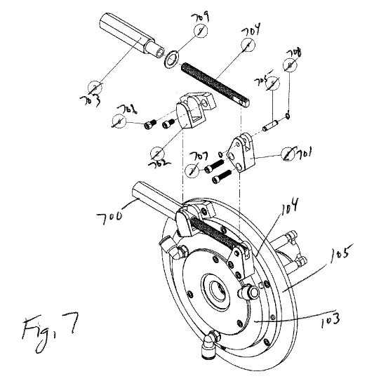

Referring to FIG. 7, an exploded view of the adjustment assembly 700 for the adjustable sizing sleeves of FIGS. 3-6 is shown. As is shown in FIG. 7, the adjustment assembly for the adjustable sizing sleeves of FIGS. 3-6 includes adjustment bracket 701 that is attached via screws 707 to the retaining ring 104 that holds the distributor plate 103 in engagement with the back plate 105 of the sizing sleeve assembly. The adjustment assembly further includes adjustment bracket 702 that is attached to the back plate 105 of the sizing sleeve assembly via screws 706. One end of all-thread 704 is retained within adjustment bracket 701 via grooved pin 705 and retaining rings 708. Threaded adjustment bushing 703 is threaded onto the other end of all-thread 704, and bushing 703 is retained within a slot formed within adjustment bracket 702. Washer 709 is located on the cylindrical outer surface of the end of bushing 703 that is threaded on all-thread 704, to provide a bearing surface between bushing 703 and an outer edge of bracket 702. This allows bushing 703 to be rotated about all-thread 704. As bushing 703 is tightened onto all-thread 704, brackets 701 and 702 are urged to rotate toward one another, causing the back plate 105 (or back plate/support bar mounting plate combination as shown in FIG. 6) of the sizing sleeve assembly to rotate counter-clockwise (when looking from the front of the assembly as is shown in FIG. 7) about the distributor plate 103 of the sizing sleeve assembly. This causes the rear/outlet end of the sizing sleeve to be twisted counter-clockwise, while the front/inlet end of the sleeve remains fixed. This results in the sizing sleeve to tighten like a spring and reduces the diameter of the inner surface of the hollow, generally cylindrical sleeve 101. As bushing 703 is loosened off of all-thread 704, brackets 701 and 702 are urged to rotate away from one another due to the spring-force that is stored in the tightened/wound sizing sleeve. As bushing 703 is loosened, the spring-force of the sizing sleeve urges the back plate 105 (or back plate/support bar mounting plate combination) to rotate clockwise about the distributor plate 103.

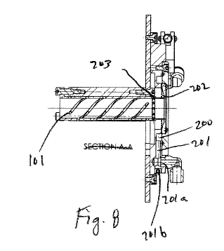

Referring to FIG. 8, a section view of the adjustable sizing sleeve assembly embodiment of FIGS. 3 and 4 is shown. Section A-A of FIG. 8 shows details regarding the water channel 201 formed in the distributor plate 103 and the water chamber 200 formed between the distributor plate and the cover plate.

The sizing sleeve 101 is a generally hollow, cylindrical body with a gap cut or otherwise formed in the body in the shape of a triple helix with 1.5 rev. pitch. It will be appreciated that other helical shapes (i.e. single, double, quadruple, etc. helix) and other pitches for the gap may be utilized without departing from the spirit and scope of the instant invention. The helical gap allows the sleeve to be twisted by rotating the opposing ends in opposite directions and resulting in a contraction of the inner diameter of the cylinder. This provides the adjustment for varying diameters of pipe to be calibrated utilizing the sleeve.

The helical gap allows the sleeve to be compressed evenly around its entire circumference over the length of the gap. This results in a pipe that is more perfectly round than adjustable sleeves of the prior art. In addition, the helix-shaped gap eliminates surface imperfections caused by material tending to flow into the gap, as the entire circumference of the material is always forced across a gapless surface after crossing a portion of the gap.

As is shown in FIG. 8, the helix-shaped gap does not extend all the way through the sleeve body to either the front or rear ends of the sleeve. As a result, when the ends of the sleeve are twisted to reduce the inner diameter of the cylinder, the inner diameter at each end of the cylinder will be greater than the inner diameter throughout the central portion of the cylinder. This allows the material being calibrated to exit the sleeve with no flat spots as the gapless transition from the end of the gap will smooth any flat spots created by material tending to flow into the gap. Then as the diameter of the cylinder of the sizing sleeve increases further toward the end, the material being calibrated will no longer be compressed or shaped by the sleeve and will remain round and without surface imperfections.

As is shown in FIG. 8 the rear surface of the annular front end of the sizing sleeve 101 includes an angled cutout or void formed from its circumference inward toward the body of the sleeve. This cutout/void provides a channel 202 for water to flow from the water chamber discussed above and around the front-most portion of the sleeve. The water flows between the rear surface of the annular front end of the sleeve and the front, notched surface of the distributor plate to provide a constant flow of water around the sleeve. The water then flows from the front-most portion of the sleeve towards the rear end of the sleeve along the outer surface of the sleeve through a gap 203 between the outer surface of the sleeve 101 and the surface of the inner-most ring of (or bore through) the distributor plate 103. The notched surface 205 is located at the inner-most concentric ring of the distributor plate. The size and shape of the notched surface is designed to provide a high Reynolds number and high pressure to provide sufficient cooling of the front-most portion of the sleeve to result in maximum heat transfer between the outer surface of the material being extruded and the inner surface of the front-most portion of the sleeve to fully solidify the entire surface of the material being extruded. The amount of cooling, Reynolds number and amount of water to provide is calculated based upon the glass transition temperature of the material being extruded. The number of grooves/notches may be increased or decreased depending upon the amount of cooling that is necessary or desired. In a preferred embodiment, a relatively low glass transition temperature is utilized so that a variety of different materials may be utilized. In the embodiments shown and discussed herein, the sum of the cross-sectional area of the notches in the direction of the fluid flow path is generally ½ the cross sectional area of the header in the direction of the fluid flow path. This results in a constant fluid pressure in the header and a high velocity of fluid flow from the header through the notches. In addition, the notches are positioned around the header at equal distances from one another to provide equal pressure around the entire header and sleeve. It will be appreciated that the number of notches, dimensions of the notches, and dimensions of the header may vary depending upon the amount of cooling desired. In one preferred embodiment, the number of notches is varied depending upon the amount of cooling desired, while the dimensions of the notches and dimensions of the header remain constant.

The flow of water (or coolant) described herein causes the front-most portion of the sleeve to fully solidify the very outer surface of the material being extruded, before the material reaches the end of the front-most portion of the sleeve (i.e. in the first 0.5 inches of the sleeve shown, a concentric vacuum slot with holes that help to pre-size the part prior to the helical gap in the sleeve). This results in the outer surface of the material being extruded to be in continuous contact with the inner surface of the front-most portion of the sleeve as it is feed forward, and results in fewer imperfections than sleeves of the prior art.

In operation the sleeve is tightened (“wound”) in the manner discussed above to compress the inner diameter of the sleeve creating a minimum calibration diameter for which the sleeve has been designed. The sleeve is “unwound” or loosened to decompress or expand the sleeve to its maximum calibration diameter for the sleeve has been designed. When the sleeve is compressed or wound, the floating support bars (in the embodiments shown in FIGS. 4 and 6) are utilized at their maximum length, while when the sleeve is unwound, the tabs of the rear end of the sleeve are located at the minimum length of the support bars.

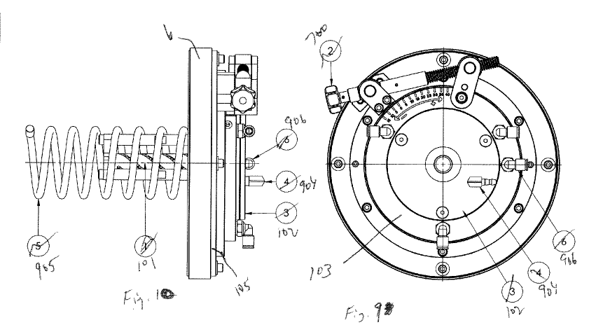

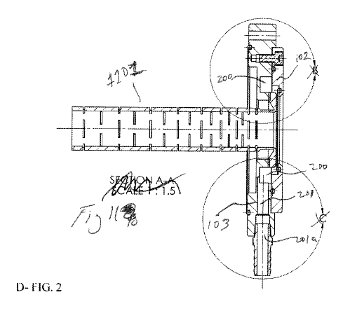

Referring to FIGS. 9 and 10, another embodiment of the adjustable sizing sleeve assembly of the instant invention is shown that includes additional cooling and lubricator features. The adjustable sizing sleeve assembly shown in FIGS. 9 and 10 is constructed in essentially the same manner as those described above with respect to FIGS. 3-8, including (but not limited to) cover plate 102, distributor plate 103, backing plate 105 (attached to vacuum sizing unit 6), sizing sleeve 101 and sizing sleeve adjustment assembly 700. In addition, in the embodiment shown in FIGS. 9 and 10, cover plate 102 functions as a lubricator plate and includes supply fitting 904 attached to the inlet of a channel that extends through cover plate 102 to allow lubricator fluid to be supplied to the interior of the sizing sleeve. The embodiment shown in FIGS. 9 and 10 further includes a cooling spiral 905 that generally wraps around the exterior of sizing sleeve 101. The cooling spiral 905 is attached to the back side of distributor plate 103 and receives cooling fluid from supply fitting 906 that is connected to an inlet of a channel that extends through distributor plate 103. Cooling fluid is pumped into cooling spiral 905 through supply fitting 906 to provide additional cooling along the length of sizing sleeve 101. It will be appreciated that the cooling spiral assembly and the lubricator supply assembly shown in this embodiment may be utilized independent with one another, and also may be utilized (in combination or independently) with any of the embodiments of the invention disclosed herein, as well as in connection with any other calibration assemblies now known or hereinafter developed.

Fixed Sizing Sleeve with High Intensity Cooling Feature

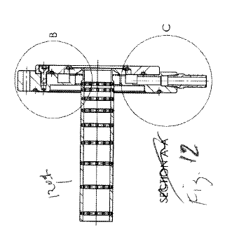

Referring to FIGS. 11 and 12, sectional views of several embodiments of fixed diameter sizing sleeve assemblies of the instant invention are shown which also include the high intensity cooling feature of the instant invention that is discussed above. Nevertheless, it will be appreciated that the fixed diameter sizing sleeve assemblies discussed herein my be utilized without the high intensity cooling feature, and/or that the high intensity cooling feature may be utilized with other calibration assemblies including but not limited to other fixed diameter sizing sleeves, adjustable dimension sizing sleeves, or calibration systems for profiles.

FIG. 11 shows a first embodiment of a fixed diameter sizing sleeve of the instant invention. FIG. 12 shows a second embodiment of a fixed diameter sizing sleeve of the instant invention. The assemblies of FIGS. 11 and 12 are constructed in similar manner to the assembly discussed above, including the distributor plate 103, and cover plate 102, however, the back plate, retaining ring, adjustment assembly and support bars are not necessary since this is a fixed diameter sleeve. Furthermore, in the embodiments shown in FIGS. 11 and 12, the inlet 201 a of water channel 201 is located in the side of distributor plate 103, rather than on the front face of the ₚlate. The sleeve 1101 of FIG. 11 includes slots machined through the body of the sleeve, while the sleeve 1201 of FIG. 12 includes rings of holes machined through the body of the sleeve.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. An adjustable sizing sleeve assembly comprising:
a generally hollow, cylindrical sleeve body; and
a helical gap formed generally along the length of said body.

2. The adjustable sizing sleeve assembly as claimed in claim 1 wherein said helical gap comprises a triple helix with 1.5 rev. pitch.

3. The adjustable sizing sleeve assembly as claimed in claim 1 wherein said helical gap terminates prior to a front end and prior to a rear end of said sleeve.

4. The adjustable sizing sleeve assembly as claimed in claim 1 wherein said sleeve is associated with a vacuum sizing unit.

5. The adjustable sizing sleeve assembly as claimed in claim 1 further comprising an adjustment mechanism associated with said sleeve.

6. The adjustable sizing sleeve assembly as claimed in claim 5 wherein said adjustment mechanism rotates a rear end of said sleeve relative to a front end of said sleeve.

7. The adjustable sizing sleeve assembly as claimed in claim 5 wherein said front end of said sleeve is in a fixed position rotationally.

8. The adjustable sizing sleeve assembly as claimed in claim 1 wherein said sleeve includes an annular front end associated with a distributor plate.

9. The adjustable sizing sleeve assembly as claimed in claim 8 further comprising a fluid channel between said annual front end of said sleeve and said distributor plate.

10. The adjustable sizing sleeve as claimed in claim 9 wherein said fluid channel comprises one or more notches within a surface of said distributor plate.

11. The adjustable sizing sleeve as claimed in claim 10 wherein the fluid channel comprises multiple notches positioned equal distances apart from one another.

12. The adjustable sizing sleeve as claimed in claim 9 wherein a size and shape of said fluid channel is selected to provide a high Reynolds number and high pressure to provide sufficient cooling of a front-most portion of said sleeve to result in maximum heat transfer between an outer surface of a material being extruded through said sleeve and an inner surface of said front-most portion of said sleeve to fully solidify the entire surface of the material being extruded.

13. The adjustable sizing sleeve as claimed in claim 12 wherein a cross-sectional area of said fluid channel is generally one half of a cross sectional area of a header in which said fluid channel is formed.

14. A high intensity cooling system for an extrusion calibration system, said cooling system comprising:
a front end of a calibration system extending outward generally transverse from said calibration system;
a distributor plate associated with said front end; and
a fluid channel between said front end and said distributor plate.

15. The system claimed in claim 14 wherein said fluid channel comprises one or more notches within a surface of said distributor plate.

16. The system as claimed in claim 15 wherein the fluid channel comprises multiple notches positioned equal distances apart from one another.

17. The system as claimed in claim 14 wherein a size and shape of said fluid channel is selected to provide a high Reynolds number and high pressure to provide sufficient cooling of a front-most portion of said calibration system to result in maximum heat transfer between an outer surface of a material being extruded through said calibration system and an inner surface of said front-most portion of said calibration system to fully solidify the entire surface of the material being extruded.

18. The system as claimed in claim 14 wherein said calibration system comprises a sleeve.

19. The system as claimed in claim 18 wherein said sleeve is adjustable.

20. A method of calibrating the size of an extruded material, the method comprising the steps of:
feeding an extruded material through a calibrator of a vacuum sizing unit; and
cooling a front-most portion of said calibrator to fully solidify the very outer surface of the extruded material within said front-most portion of said calibrator.

21. The method as claimed in claim 20 wherein said front-most portion of said calibrator comprises the first 0.5 inches of the calibrator.

22. The method as claimed in claim 20 wherein said calibrator comprises a sizing sleeve for extruding a circular profile.
